(19) United States
(12) Patent Application Publication
(10) Pub. No.: US 2025/0220400 A1
(43) Pub. Date: Jul. 3, 2025

(54) VEHICLE CONTROL SYSTEM AND ELECTRONIC CONTROL DEVICE

(71) Applicant: Hitachi Astemo, Ltd., Hitachinaka-shi, Ibaraki (JP)

(72) Inventor: Masakazu IKEDA, Hitachinaka-shi, Ibaraki (JP)

(73) Assignee: Hitachi Astemo, Ltd., Hitachinaka-shi, Ibaraki (JP)

(21) Appl. No.: 18/844,000

(22) PCT Filed: Jun. 24, 2022
(86) PCT No.: PCT/JP2022/025252

§ 371 Date: Sep. 4, 2024

(51) Int. Cl. H04W 4/48; G06T 1/20

(52) U.S. Cl. CPC H04W 4/48; G06T 1/20

(57) ABSTRACT

A vehicle control system includes: a first arithmetic unit that acquires arithmetic data and is capable of executing arithmetic processing; a second arithmetic unit that is connected to a subsequent stage of the first arithmetic unit via a network and is capable of executing arithmetic processing of the arithmetic data input from the first arithmetic unit via the network; a first measurement unit that measures a band load of the network; a second measurement unit that measures a processing load of the arithmetic processing by the second arithmetic unit; and a switching unit that causes the first arithmetic unit to perform a part of the arithmetic processing performed by the second arithmetic unit in place of the second arithmetic unit according to the processing load, and adjusts a data amount of the arithmetic data output from the first arithmetic unit to the second arithmetic unit according to the band load.

### TECHNICAL FIELD

The present invention relates to a vehicle control system and an electronic control device.

### BACKGROUND ART

In recent years, a plurality of electronic control device (ECU: electronic control unit) have been mounted on a vehicle. The plurality of ECUs are installed at various places in the vehicle, and each cooperate to implement one in-vehicle application. Therefore, data communication between the ECUs is required, and as a means for this, there is a method in which the ECUs are connected by a communication line to form an in-vehicle network. In a configuration of a next-generation in-vehicle network, zone architecture is in progress. In the zone architecture, image processing is integrated into an integrated ECU, a Zone ECU serves as a network HUB, and a sensor, an actuator, or the like transmits and receives information data to and from the integrated ECU via the Zone ECU. Note that as the number of Zone ECUs and the number of sensors connected to the Zone ECUs increase, the load on the in-vehicle network increases, and image processing by the integrated ECU also increases. Therefore, there is a problem that a load of a central processing unit (CPU) of the integrated ECU also increases. For example, in a case where an image sensor such as a camera increases the resolution and frame rate of a detection image (see PTL 1), there arises a problem that the load of the in-vehicle network and the load of the CPU of the integrated ECU increase.

### CITATION LIST

### Patent Literature

PTL 1: WO 2021/131064 A

### SUMMARY OF INVENTION

### Technical Problem

PTL 1 describes “an image processing device including: a decision unit for deciding, on the basis of a status related to movement of a moving body, the image quality of an image for sensing an object outside the moving body, and an output unit for outputting an image of the image quality decided by the decision unit”. Note that, in the technology described in PTL 1, in a case where the resolution and the frame rate of an image of a device that captures an image in a predetermined direction of a moving body are increased, the amount of data transmitted to the integrated ECU via the in-vehicle network increases. Therefore, in a vehicle control system which includes a first arithmetic unit and a second arithmetic unit connected via the in-vehicle network and in which the second arithmetic unit includes the CPU, there is a problem that the band load of the in-vehicle network and the processing load of the second arithmetic unit (for example, the CPU of the integrated ECU) also increase.

The present invention has been made in view of such a situation, and an object of the present invention is to reduce a band load of a network between a first arithmetic unit and a second arithmetic unit and to reduce a processing load of the second arithmetic unit in a vehicle control system including the first arithmetic unit and the second arithmetic unit.

### Solution to Problem

A vehicle control system according to the present invention includes: a first arithmetic unit that acquires arithmetic data and is capable of executing arithmetic processing; a second arithmetic unit that is connected to a subsequent stage of the first arithmetic unit via a network and is capable of executing arithmetic processing of the arithmetic data input from the first arithmetic unit via the network; a first measurement unit that measures a band load of the network; a second measurement unit that measures a processing load of the arithmetic processing by the second arithmetic unit; and a switching unit that causes the first arithmetic unit to perform a part of the arithmetic processing performed by the second arithmetic unit in place of the second arithmetic unit according to the processing load, and adjusts a data amount of the arithmetic data output from the first arithmetic unit to the second arithmetic unit according to the band load.

### Advantageous Effects of Invention

According to the present invention having the above configuration, in the vehicle control system including the first arithmetic unit and the second arithmetic unit, the band load of the network between the first arithmetic unit and the second arithmetic unit can be reduced, and the processing load of the second arithmetic unit can be reduced.

### BRIEF DESCRIPTION OF DRAWINGS

FIG. 1 is a block diagram illustrating a configuration example of a vehicle control system according to a first embodiment of the present invention.

FIG. 2 is a block diagram illustrating a configuration example of an electronic control device according to the first embodiment of the present invention.

FIG. 3A is a diagram for explaining a flow of each processing in the electronic control device according to the first embodiment of the present invention.

FIG. 3B is a diagram illustrating an example of the flow of each processing in the electronic control device according to the first embodiment of the present invention.

FIG. 4 is a flowchart illustrating a procedure of switching processing in the electronic control device according to the first embodiment of the present invention.

FIG. 5 is a block diagram illustrating a configuration example of an electronic control device according to a second embodiment of the present invention.

FIG. 6 is a block diagram illustrating a configuration example of an electronic control device according to a third embodiment of the present invention.

FIG. 7 is a block diagram illustrating a configuration example of an electronic control device according to a fourth embodiment of the present invention.

FIG. 8 is a flowchart illustrating a procedure of switching processing in the electronic control device according to the fourth embodiment of the present invention.

FIG. 9 is a block diagram illustrating a configuration example of an electronic control device according to a fifth embodiment of the present invention.

FIG. 10 is a block diagram illustrating a configuration example of a vehicle control system according to a sixth embodiment of the present invention.

FIG. 11 is a block diagram illustrating a configuration example of an electronic control device according to the sixth embodiment of the present invention.

### DESCRIPTION OF EMBODIMENTS

Hereinafter, embodiments of the present invention will be described with reference to the accompanying drawings. In the present specification and the drawings, components having substantially the same function or configuration are denoted by the same reference numerals, and redundant description is omitted.

### First Embodiment

### Configuration Example of Vehicle Control System

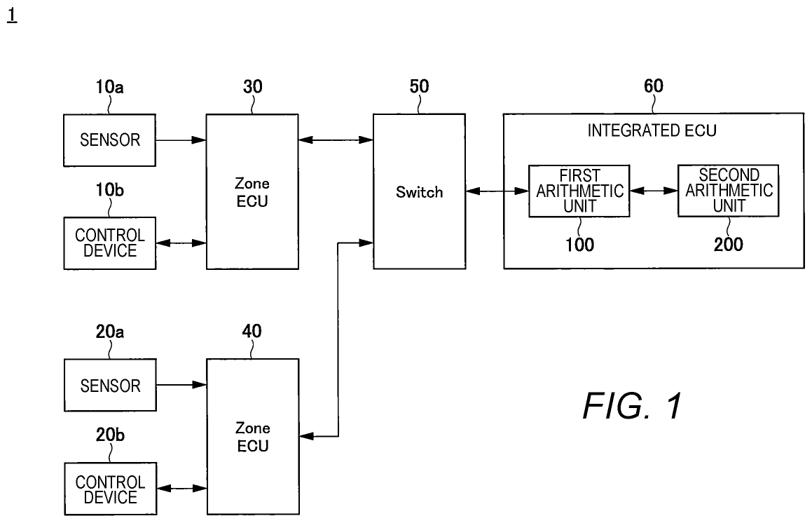

FIG. 1 is a block diagram illustrating a configuration example of a vehicle control system 1 according to a first embodiment of the present invention. As illustrated in FIG. 1, the vehicle control system 1 includes a sensor 10a and a control device 10b, a sensor 20a and a control device 20b, a Zone ECU 30, a Zone ECU 40, a Switch 50, and an integrated ECU 60 (electronic control device). The sensor 10a and the control device 10b are connected to the Zone ECU 30, and the Zone ECU 30 is connected to the integrated ECU 60 via the Switch 50. The sensor 20a and the control device 20b are connected to the Zone ECU 40, and the Zone ECU 40 is connected to the integrated ECU 60 via the Switch 50.

The sensor 10a and the sensor 20a are, for example, an imaging device or the like, which acquires image information, such as a camera. The control device 10b and the control device 20b are, for example, control devices of actuators.

When receiving information data from either the sensor 10a or the control device 10b connected to the Zone ECU 30, the Zone ECU 30 transmits the received information data to the integrated ECU 60 by using, for example, a high-speed protocol such as Ethernet (registered trademark). Note that the Zone ECU 30 may periodically acquire information data from the sensor 10a and the control device 10b. In addition, the Zone ECU 30 converts the image data received from the sensor 10a into an image frame, and converts the control data received from the control device 10b into a control frame. In the following description, the image frame and the control frame are collectively referred to as “frames”. In addition, the Zone ECU 30 receives control data for the control device 10b from the integrated ECU 60 and outputs the control data to the control device 10b. Note that the operation of the Zone ECU 40 is similar to the operation of the Zone ECU 30, and thus redundant description will be omitted.

The Switch 50 selects information data received from the Zone ECU 30 and the Zone ECU 40 on the basis of a priority order registered in advance and transmits the information data to the integrated ECU 60. For example, in a case where the priority of the Zone ECU 30 is higher than the priority of the Zone ECU 40, the Switch 50 first transmits the information data received from the Zone ECU 30 to the integrated ECU 60.

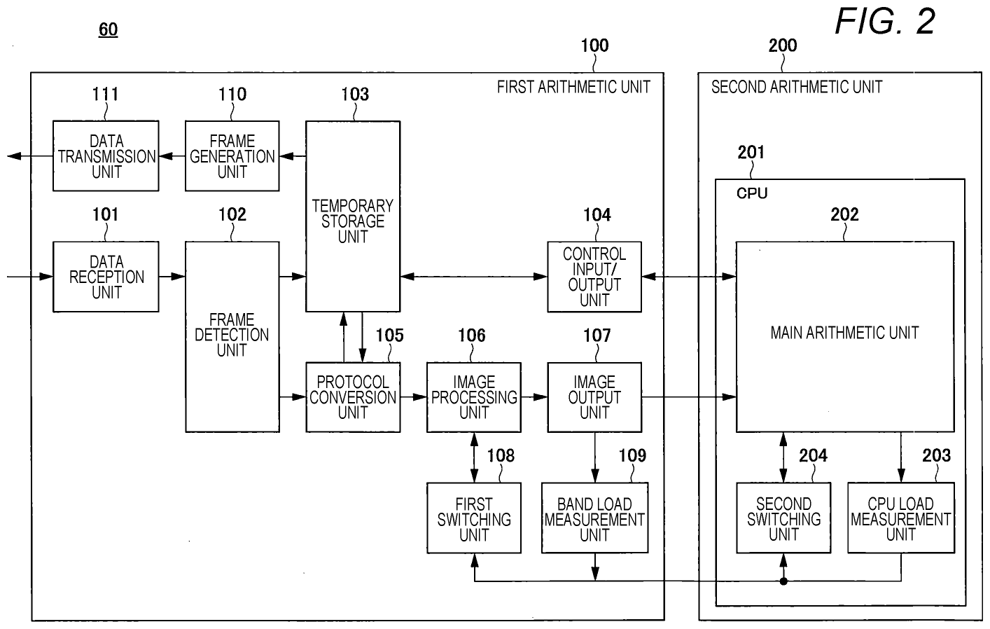

The integrated ECU 60 acquires, as arithmetic data, the information data received from the Zone ECU 30 and the Zone ECU 40, and executes image processing and various types of arithmetic processing for generating vehicle control information and the like. The integrated ECU 60 includes a first arithmetic unit 100 and a second arithmetic unit 200. The functions of the first arithmetic unit 100 and the second arithmetic unit 200 will be described in detail with reference to FIG. 2 described later.

Although FIG. 1 illustrates an example in which one sensor and one control device are connected to each Zone ECU, the present invention is not limited thereto, and a plurality of sensors and control devices may be connected to each Zone ECU. In addition, although FIG. 1 illustrates an example in which two Zone ECUs are provided in the vehicle control system 1, the present invention is not limited thereto, and two or more Zone ECUs may be provided.

### Configuration Example of Electronic Control Device

FIG. 2 is a block diagram illustrating a configuration example of an electronic control device (integrated ECU 60) according to the present embodiment. The integrated ECU 60 includes a first arithmetic unit, a second arithmetic unit, a first measurement unit, and a second measurement unit. In the configuration example illustrated in FIG. 2, the integrated ECU 60 includes a first arithmetic unit 100 having a first measurement unit (band load measurement unit 109), a second arithmetic unit 200 having a second measurement unit (CPU load measurement unit 203), and a switching unit (first switching unit 108 and second switching unit 204). The first arithmetic unit 100 and the second arithmetic unit 200 are connected so as to be able to transmit and receive information data to and from each other.

The first arithmetic unit (first arithmetic unit 100) can acquire arithmetic data from each Zone ECU and execute arithmetic processing. As illustrated in FIG. 2, the first arithmetic unit 100 includes a data reception unit 101, a frame detection unit 102, a temporary storage unit 103, a control input/output unit 104, a protocol conversion unit 105, an image processing unit 106, an image output unit 107, a switching unit (first switching unit 108), a first measurement unit (band load measurement unit 109), a frame generation unit 110, and a data transmission unit 111.

The input side of the data reception unit 101 is connected to the Zone ECU 30 and the Zone ECU 40 via the external Switch 50. In addition, the output side of the data reception unit 101 is connected to the frame detection unit 102. The frame detection unit 102 is connected to each of the temporary storage unit 103 and the protocol conversion unit 105. The temporary storage unit 103 is connected to the control input/output unit 104. The control input/output unit 104 is connected to a main arithmetic unit 202 of the second arithmetic unit 200. The protocol conversion unit 105 is connected to the image processing unit 106. The image processing unit 106 is connected to the image output unit 107. The image output unit 107 is connected to the main arithmetic unit 202 of the second arithmetic unit 200. The first switching unit 108 is connected between the image processing unit 106 and the CPU load measurement unit 203 of the second arithmetic unit 200. The band load measurement unit 109 is connected between the image output unit 107 and the second switching unit 204 of the second arithmetic unit 200. In addition, the temporary storage unit 103, the frame generation unit 110, and the data transmission unit 111 are connected in this order, and the data transmission unit 111 is also connected to the Zone ECU 30 and the Zone ECU 40 via the external Switch 50.

The data reception unit 101 receives arithmetic data such as image data and control data from the Zone ECU 30 and the Zone ECU 40 according to a high-speed protocol such as Ethernet (registered trademark), and outputs the arithmetic data to the frame detection unit 102.

The frame detection unit 102 identifies whether the frame input from the data reception unit 101 is the image data or the control data. Then, when identifying that the frame is the control data, the frame detection unit 102 outputs the control data to the temporary storage unit 103. On the other hand, when identifying that the frame is the image data, the frame detection unit 102 outputs the image data to the protocol conversion unit 105.

The temporary storage unit 103 temporarily stores the control data input from the frame detection unit 102, and then outputs the control data to the control input/output unit 104. In addition, when control data for the external control device 10b and control device 20b is input from the control input/output unit 104, the temporary storage unit 103 temporarily stores the control data and then outputs the control data to the frame generation unit 110.

The control input/output unit 104 transmits the control data input from the temporary storage unit 103 to the main arithmetic unit 202 of the second arithmetic unit 200. In addition, the control input/output unit 104 receives the control data for the external control device 10b and control device 20b from the main arithmetic unit 202 of the second arithmetic unit 200, and outputs the control data to the temporary storage unit 103.

The protocol conversion unit 105 converts the image data input from the frame detection unit 102 from an input protocol to an output protocol and outputs the converted image data to the image processing unit 106. Note that the input protocol is, for example, a transfer protocol (Ethernet (registered trademark) or the like) defined between the Zone ECU 30 and the Zone ECU 40, and the integrated ECU 60. The output protocol is a transfer protocol defined between the first arithmetic unit 100 (image output unit 107) and the second arithmetic unit 200 (main arithmetic unit 202). Here, as the output protocol, a protocol applied to an interface dedicated to images such as a mobile industry processor interface (MIPI) is assumed. In addition, the protocol conversion unit 105 inputs and outputs image data to and from the temporary storage unit 103.

The image processing unit 106 performs image processing (arithmetic processing) such as processing of converting the image data input from the protocol conversion unit 105 into an RGB image, for example, and outputs the processed image data to the image output unit 107 and the first switching unit 108. Note that the image processing may not be performed in the image processing unit 106. In this case, the image processing unit 106 outputs the image data input from the protocol conversion unit 105 to the image output unit 107 and the first switching unit 108 as they are.

The image output unit 107 transmits the image data before processing or after processing input from the image processing unit 106 to the first measurement unit (band load measurement unit 109) and the main arithmetic unit 202 of the second arithmetic unit 200. Note that the image data is transferred between the first arithmetic unit 100 (image output unit 107) and the second arithmetic unit 200 (main arithmetic unit 202) by an interface dedicated to an image such as MIPI.

According to the processing load measured by the second measurement unit (CPU load measurement unit 203) of the second arithmetic unit (second arithmetic unit 200), the switching unit (first switching unit 108) causes the first arithmetic unit (first arithmetic unit 100) to perform a part (for example, image processing) of the arithmetic processing performed by the second arithmetic unit (second arithmetic unit 200) in place of the second arithmetic unit. For example, in a case where a CPU load (processing load) of a CPU 201 measured by the CPU load measurement unit 203 described later exceeds a predetermined processing load upper limit value (70% or the like), the first switching unit 108 outputs an instruction to execute image processing in the image processing unit 106 to the image processing unit 106. Note that the predetermined processing load upper limit value is an upper limit value of a processing load set in advance for the processing load of the CPU 201 of the second arithmetic unit 200.

In addition, the switching unit (first switching unit 108) adjusts the data amount of the arithmetic data output from the first arithmetic unit (first arithmetic unit 100) to the second arithmetic unit (second arithmetic unit 200) according to the band load measured by the first measurement unit (band load measurement unit 109). The band load is a usage rate of a band of the network. For example, in a case where the band load measured by the band load measurement unit 109 exceeds a predetermined band load upper limit value (75% or the like), the first switching unit 108 outputs an instruction to execute image data extraction processing to the image processing unit 106, thereby adjusting the data amount of the arithmetic data output to the second arithmetic unit 200. Note that the predetermined band load upper limit value is an upper limit value of a band load set in advance for the band load of the in-vehicle network.

The first measurement unit (band load measurement unit 109) measures a band load, which is a band usage rate of the network between the first arithmetic unit 100 and the second arithmetic unit 200, on the basis of the data amount of the image data input from the image output unit 107, and outputs a measurement result to the first switching unit 108. In addition, the band load measurement unit 109 also outputs the measurement result of the band load to the second switching unit 204 of the second arithmetic unit 200. Note that, for example, the band load is represented as an occupancy rate (50% or the like) of the band occupied by the amount of data to be transferred between the first arithmetic unit 100 (image output unit 107) and the second arithmetic unit 200 (main arithmetic unit 202) with respect to the entire band. Here, the entire band is the entire band of a communication path (network) between the first arithmetic unit 100 and the second arithmetic unit 200.

The frame generation unit 110 generates a frame for the control data for the external control device 10b and control device 20b input from the temporary storage unit 103, and outputs the frame to the data transmission unit 111.

The data transmission unit 111 transmits the control data input from the frame generation unit 110 to the external Zone ECU 30 or Zone ECU 40 by a high-speed protocol such as Ethernet (registered trademark).

The second arithmetic unit (second arithmetic unit 200) is connected to a subsequent stage of the first arithmetic unit (first arithmetic unit 100) via a network, and can execute arithmetic processing of arithmetic data input from the first arithmetic unit (first arithmetic unit 100) via the network. As illustrated in FIG. 2, the second arithmetic unit 200 includes the CPU 201. The CPU 201 includes the main arithmetic unit 202, the second measurement unit (CPU load measurement unit 203), and the switching unit (second switching unit 204). The main arithmetic unit 202, the CPU load measurement unit 203, and the second switching unit 204 are connected to each other. In addition, the main arithmetic unit 202 is connected to the control input/output unit 104 and the image output unit 107 of the first arithmetic unit 100. In addition, the second measurement unit (CPU load measurement unit 203) is connected to the first switching unit 108 of the first arithmetic unit 100. In addition, the second switching unit 204 is connected to the band load measurement unit 109 of the first arithmetic unit 100.

The main arithmetic unit 202 performs image processing (arithmetic processing) on the image data (arithmetic data) received from the image output unit 107 of the first arithmetic unit 100, and performs processing (arithmetic processing) such as object detection and object recognition to generate control data. In addition, the main arithmetic unit 202 transmits the generated control data to the control input/output unit 104 of the first arithmetic unit 100. Note that the main arithmetic unit 202 performs the image processing when receiving an instruction to execute the image processing from the second switching unit 204. On the other hand, when an instruction not to execute the image processing is input from the second switching unit 204, the main arithmetic unit 202 does not perform the image processing.

The second measurement unit (CPU load measurement unit 203) acquires information regarding arithmetic processing to be executed in the main arithmetic unit 202, and measures a processing load when the arithmetic processing is performed. Note that the processing load is, for example, the usage rate of the second arithmetic unit (second arithmetic unit 200, CPU 201) that generates the vehicle control information on the basis of the arithmetic data input from the first arithmetic unit (first arithmetic unit 100). In addition, the processing load may be either the amount of data to be processed in the arithmetic processing in the second arithmetic unit 200 or a processing time for which the arithmetic processing is performed in the second arithmetic unit 200. In the following description, the usage rate of the CPU 201 is referred to as a “CPU load” as an example of the processing load. Note that, for example, the CPU load is represented as a usage rate (for example, 50% or the like) of the CPU 201 for processing to be executed by the main arithmetic unit 202 (partial processing of the CPU 201) with respect to the entire processing of the CPU 201. In addition, the CPU load measurement unit 203 outputs the measured CPU load to the second switching unit 204 and also transmits the CPU load to the first switching unit 108 of the first arithmetic unit 100.

Similarly to the first switching unit 108, the switching unit (second switching unit 204) performs switching control of the arithmetic processing on the basis of the processing load measured by the second measurement unit (CPU load measurement unit 203). For example, in a case where the CPU load is less than a predetermined processing load upper limit value (70% or the like), the second switching unit 204 outputs an instruction to execute the image processing in the main arithmetic unit 202 to the main arithmetic unit 202. In addition, when execution of the extraction processing on the image data is set in the main arithmetic unit 202, the second switching unit 204 outputs an instruction to execute the extraction processing in the main arithmetic unit 202 to the main arithmetic unit 202.

### Example of Processing Order in Electronic Control Device (Integrated ECU)

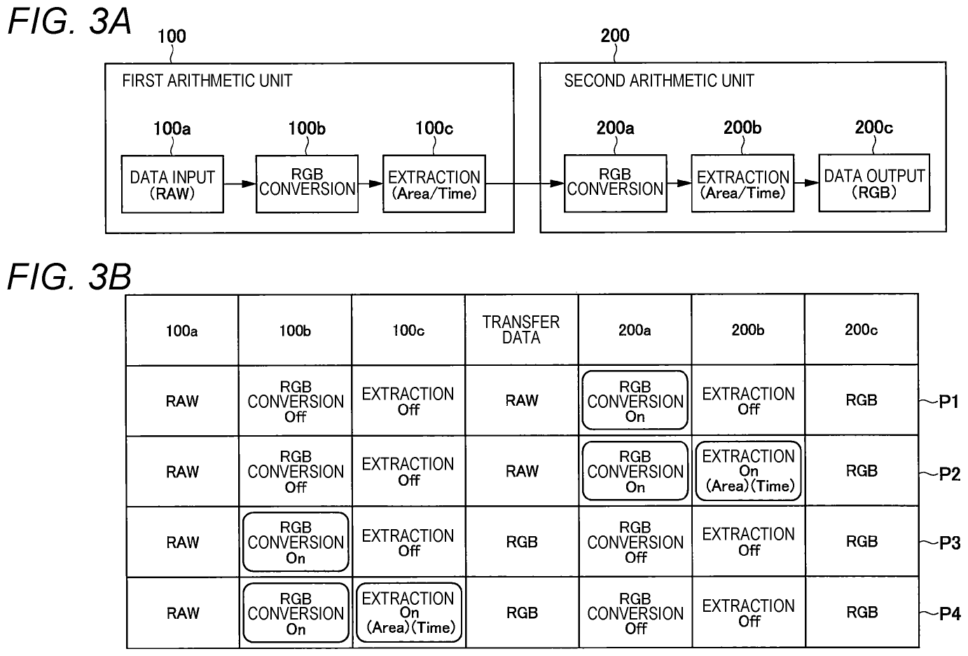

FIG. 3A is a diagram for explaining each processing in the electronic control device (integrated ECU 60) according to the present embodiment. Here, it is assumed that the input data of the integrated ECU 60 is RAW image data. A RAW image is unprocessed image data obtained from an imaging element, and each pixel has only color information of a single color and has a smaller amount of data information than RGB of color representation. Therefore, the RAW image is suitable for high-speed and large-capacity communication. In the present embodiment, the RAW image is transferred to the integrated ECU 60 by Ethernet (registered trademark) at a predetermined size and a predetermined cycle. In addition, it is assumed that the image processing for the image data is RGB conversion processing for converting a RAW image into an RGB image, and the extraction processing for the image data is area (XY axes) extraction processing or time axis extraction processing. As illustrated in FIG. 3A, the processing in the first arithmetic unit 100 of the integrated ECU 60 includes data input processing 100a, RGB conversion processing 100b, and extraction processing 100c. The processing in the second arithmetic unit 200 of the integrated ECU 60 includes RGB conversion processing 200a, extraction processing 200b, and output processing 200c.

The data input processing 100a of the first arithmetic unit 100 is image data input processing performed in the image processing unit 106. Note that the image data input to the image processing unit 106 is RAW image data after protocol conversion output from the protocol conversion unit 105.

Next to the data input processing 100a, in a case where execution of the RGB conversion processing 100b and/or the extraction processing 100c is set in the image processing unit 106, the RGB conversion processing 100b and/or the extraction processing 100c is executed (see processing examples P3 and P4 of FIG. 3B described later). Then, the image data after the image processing is output to the second arithmetic unit 200. On the other hand, in a case where the RGB conversion processing 100b and the extraction processing 100c are set to non-execution, the RGB conversion processing 100b and the extraction processing 100c are not executed (see processing examples P1 and P2 in FIG. 3B described later). In this case, the RAW image data input in the data input processing 100a is output to the second arithmetic unit 200 as it is. Note that whether or not to execute each of the RGB conversion processing 100b and the extraction processing 100c is set in advance.

When execution of the RGB conversion processing 200a and/or the extraction processing 200b is set in the main arithmetic unit 202 of the second arithmetic unit 200, the RGB conversion processing 200a and/or the extraction processing 200b is executed on the image data from the first arithmetic unit 100 (see the processing examples P1 and P2 in FIG. 3B described later). On the other hand, in a case where the RGB conversion processing 200a and the extraction processing 200b are set to non-execution, the RGB conversion processing 200a and the extraction processing 200b are not executed (see the processing examples P3 and P4 of FIG. 3B described later). Note that whether or not to execute each of the RGB conversion processing 200a and the extraction processing 200b is set in advance.

In the output processing 200c, the main arithmetic unit 202 outputs the image data after the image processing (after RGB conversion processing and after extraction processing) to a storage device as a storage destination, a server on a network, or the like. Note that in a case where the RGB conversion processing 200a and the extraction processing 200b are not executed, the main arithmetic unit 202 outputs the image data input from the first arithmetic unit 100 as it is.

FIG. 3B is a diagram illustrating an example of a processing order of each processing in the electronic control device (integrated ECU 60) described in FIG. 3A. Each column in FIG. 3B represents each processing in the first arithmetic unit 100 and the second arithmetic unit 200 or data to be processed. Each row in FIG. 3B represents the processing order from the data input processing 100a of the first arithmetic unit 100 to the output processing 200c of the second arithmetic unit 200.

The processing example P1 illustrates example 1 of a processing order in a case where the band load does not exceed the predetermined band load upper limit value and the processing load does not exceed the predetermined processing load upper limit value. Therefore, in the image processing unit 106 of the first arithmetic unit 100 illustrated in the processing example P1, the RGB conversion processing (image processing) and the extraction processing are set to non-execution (“Off”). The data to be transferred from the first arithmetic unit 100 to the second arithmetic unit 200 is RAW image data. Then, in the main arithmetic unit 202 of the second arithmetic unit 200, since the RGB conversion processing is set to execution (“On”) and the extraction processing is set to non-execution (“Off”), the RGB conversion processing 200a is executed and the extraction processing 200b is not executed. In the output processing 200c, the RGB image data after the RGB conversion processing is output.

The processing example P2 also illustrates example 2 of a processing order in a case where the band load does not exceed the predetermined band load upper limit value and the processing load does not exceed the predetermined processing load upper limit value. In the processing example P2, each processing in the first arithmetic unit 100 is similar to that in the processing example P1, and thus redundant description will be omitted. In the main arithmetic unit 202 of the second arithmetic unit 200, since the RGB conversion processing is set to execution (“On”) and the extraction processing is set to execution (“On”), the RGB conversion processing 200a and the extraction processing 200b are executed. Therefore, in the output processing 200c, the RGB image data after the RGB conversion processing and the extraction processing is output.

The processing example P3 illustrates an example of a processing order in a case where the band load does not exceed the predetermined band load upper limit value and the processing load exceeds the predetermined processing load upper limit value. Since the processing load exceeds the predetermined processing load upper limit value and the image processing (RGB conversion processing) is switched to the first arithmetic unit 100, the RGB conversion processing is set to execution (“On”) in the image processing unit 106 of the first arithmetic unit 100. In addition, since the band load does not exceed the predetermined band load upper limit value, the extraction processing is set to non-execution (“Off”) in the first arithmetic unit 100.

As illustrated in the processing example P3, in the data input processing 100a of the first arithmetic unit 100, RAW image data is input. In the image processing unit 106, since the RGB conversion processing is set to execution (“On”) and the extraction processing is set to non-execution (“Off”), the RGB conversion processing 100b is executed and the extraction processing 100c is not executed. Therefore, the data transferred from the first arithmetic unit 100 to the second arithmetic unit 200 is RGB image data, and the data amount is larger than that of the RAW image data. Then, since the RGB conversion processing and the extraction processing are set to non-execution (“Off”) in the main arithmetic unit 202 of the second arithmetic unit 200, the RGB image data input from the first arithmetic unit 100 is output as it is in the output processing 200c. As illustrated in the processing example P3, in the present embodiment, in a case where the band load does not exceed the predetermined band load upper limit value and the processing load exceeds the predetermined processing load upper limit value, the switching unit (the first switching unit 108 and the second switching unit 204) adjusts the data amount such that the data amount of the arithmetic data for which the first arithmetic unit (the first arithmetic unit 100) executes the arithmetic processing increases.

The processing example P4 illustrates an example of a processing order in a case where the band load exceeds the predetermined band load upper limit value and the processing load exceeds the predetermined processing load upper limit value. Since the processing load exceeds the predetermined processing load upper limit value and the image processing (RGB conversion processing) is switched to the first arithmetic unit 100, the RGB conversion processing is set to execution (“ON”) in the image processing unit 106 of the first arithmetic unit 100. In addition, since the band load exceeds the predetermined band load upper limit value, the extraction processing is set to execution (“ON”) in the first arithmetic unit 100.

As illustrated in the processing example P4, in the data input processing 100a of the first arithmetic unit 100, RAW image data is input. In the image processing unit 106, since the RGB conversion processing is set to execution (“ON”) and the extraction processing is set to execution (“ON”), the RGB conversion processing 100b and the extraction processing 100c are executed. Therefore, the data to be transferred from the first arithmetic unit 100 to the second arithmetic unit 200 is RGB image data after RGB conversion processing. Then, in order not to increase the data amount of the arithmetic data to be transferred from the first arithmetic unit 100 to the second arithmetic unit 200, the first arithmetic unit 100 executes extraction processing of a time axis or XY axes (area). Note that, in the processing example P4, each processing in the second arithmetic unit 200 is similar to that in the processing example P3, and thus redundant description will be omitted. As illustrated in the processing example P4, in the present embodiment, in a case where the band load exceeds the band load upper limit value and the processing load exceeds the processing load upper limit value, the switching unit (the first switching unit 108 and the second switching unit 204) adjusts the data amount such that the data amount of the arithmetic data output from the first arithmetic unit (the first arithmetic unit 100) to the second arithmetic unit (the second arithmetic unit 200) does not increase.

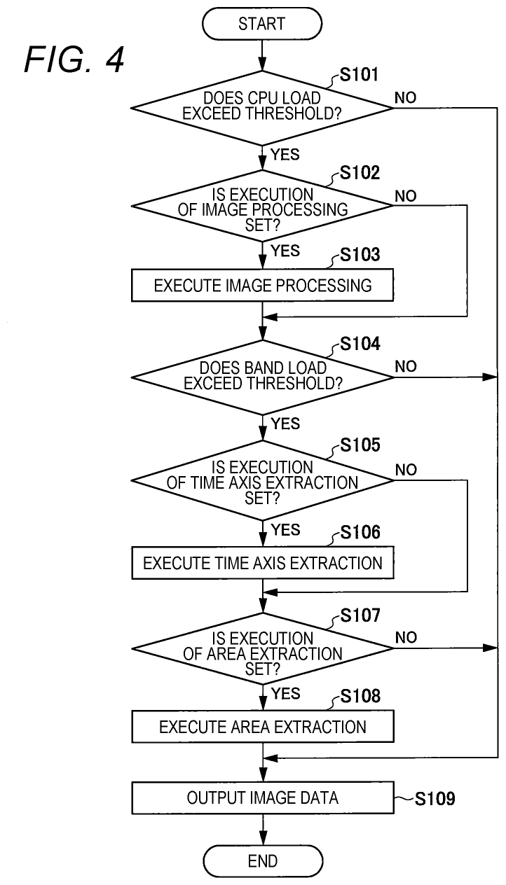

FIG. 4 is a flowchart illustrating a procedure of switching processing in the electronic control device (integrated ECU 60) according to the present embodiment. The processing described below starts when the first switching unit 108 of the first arithmetic unit 100 inputs the CPU load measured from the second measurement unit (CPU load measurement unit 203) of the second arithmetic unit 200.

First, the first switching unit 108 of the first arithmetic unit 100 determines whether the CPU load exceeds a predetermined processing load upper limit value (threshold) (step S101).

In the processing of step S101, if the first switching unit 108 determines that the CPU load does not exceed the predetermined processing load upper limit value (threshold) (NO of S101), the processing of step S109 described later is performed.

On the other hand, in the processing of step S101, if it is determined that the CPU load exceeds the predetermined processing load upper limit value (threshold) (YES in S101), the first switching unit 108 determines whether the execution of image processing (RGB conversion processing or the like) is set in the image processing unit 106 (step S102). In this processing, the first switching unit 108 acquires and determines execution setting information of the image processing from the image processing unit 106.

In the processing of step S102, if the first switching unit 108 determines that the execution of the image processing is not set (NO of S102), the processing of step S104 described later is performed.

On the other hand, in the processing of step S102, if the first switching unit 108 determines that the execution of the image processing is set (YES in S102), the first switching unit 108 outputs an instruction to execute the image processing to the image processing unit 106. Then, the image processing unit 106 executes the image processing in accordance with the instruction from the first switching unit 108 (step S103). At this time, the main arithmetic unit 202 does not execute the image processing.

After the processing of step S103 or if the processing of step S102 is NO determination, the first switching unit 108 acquires the band load measured from the band load measurement unit 109 and determines whether the band load exceeds the predetermined band load upper limit value (step S104).

In the processing of step S104, if the first switching unit 108 determines that the band load does not exceed the predetermined band load upper limit value (NO of S104), the processing of step S109 described later is performed.

On the other hand, in the processing of step S104, if it is determined that the band load exceeds the predetermined band load upper limit value (YES in S104), the first switching unit 108 determines whether the execution of time axis extraction processing is set in the image processing unit 106 (step S105). In this processing, the first switching unit 108 acquires and determines execution setting information of the time axis extraction processing from the image processing unit 106.

In the processing of step S105, if the first switching unit 108 determines that the execution of the time axis extraction processing is not set (NO of S105), the processing of step S107 described later is performed.

On the other hand, in the processing of step S105, if the first switching unit 108 determines that the execution of the time axis extraction processing is set (YES of S105), the first switching unit 108 outputs an instruction to execute the time axis extraction processing to the image processing unit 106. Then, the image processing unit 106 performs the time axis extraction processing in accordance with the instruction from the first switching unit 108 (step S106). At this time, the time axis extraction processing is not executed in the main arithmetic unit 202.

After the processing of step S106 or if the processing of step S105 is NO determination, the first switching unit 108 determines whether the execution of the area (XY axes) extraction processing is set in the image processing unit 106 (step S107).

In the processing of step S107, if the first switching unit 108 determines that the execution of the area extraction processing is not set (NO of S107), the processing of step S109 described later is performed.

On the other hand, in the processing of step S107, if the first switching unit 108 determines that the execution of the area extraction processing is set (YES in S107), the first switching unit 108 outputs an instruction to execute the area extraction processing to the image processing unit 106. Then, the image processing unit 106 performs the area extraction processing in accordance with the instruction from the first switching unit 108 (step S108). At this time, the area extraction processing is not executed in the main arithmetic unit 202.

After the processing of step S108, if the processing of step S101 is NO determination, and the processing of step S104 is NO determination or the processing of step S107 is NO determination, the image processing unit 106 outputs the image data to the image output unit 107 (step S109). After the processing of step S109, the switching processing in the integrated ECU 60 ends.

Note that the integrated ECU 60 may dynamically perform the above-described switching processing of the image processing during data transfer, or may statically switch the image processing by giving, as an initial setting value, a data amount predicted based on the number of sensors, image quality setting, and the like at a first point of time. In addition, in a case where the integrated ECU 60 dynamically switches the image processing, it is necessary to consider continuity of data. In addition, in a case where the integrated ECU 60 handles image data from a plurality of sensors, the image processing may be switched collectively for the image data from all the sensors, or the image processing may be switched for each sensor. In addition, in a case where the data information amount of the image data from some of the plurality of plurality of sensors increases, the integrated ECU 60 may switch the image processing for the image data of the sensor of which data amount has increased, or may switch the image processing collectively for the image data of all the sensors. In addition, in a case where the integrated ECU 60 increases the data amount in all of the plurality of sensors on the basis of, for example, the CPU load or the band load of the in-vehicle network, a configuration for controlling the sensor side to increase the data amount becomes unnecessary, so that there is an advantage that the system can be simplified. In addition, in a case where the MIPI protocol is applied to the in-vehicle network, the transferred data is transferred by being tagged to Virtual Number, and thus the first arithmetic unit 100 or the second arithmetic unit 200 may perform control to switch the image processing for each Virtual Number.

### [Effects]

As described above, in the electronic control device (integrated ECU 60) according to the first embodiment, the processing load of the CPU 201 of the second arithmetic unit 200 is measured, and in a case where the measured processing load exceeds the predetermined processing load upper limit value, the image processing scheduled to be executed by the CPU 201 is switched to and executed by the image processing unit 106 of the first arithmetic unit 100. Therefore, the processing load of the CPU 201 of the electronic control device (integrated ECU 60) according to the first embodiment can be reduced. In addition, in the present embodiment, the band load of the in-vehicle network is measured, and in a case where the measured band load exceeds the predetermined band load upper limit value, the first arithmetic unit 100 performs image data extraction processing or the like, thereby performing control to reduce the amount of image data transferred from the first arithmetic unit 100 to the second arithmetic unit 200. Therefore, in the present embodiment, the band load of the in-vehicle network can be reduced.

### Second Embodiment

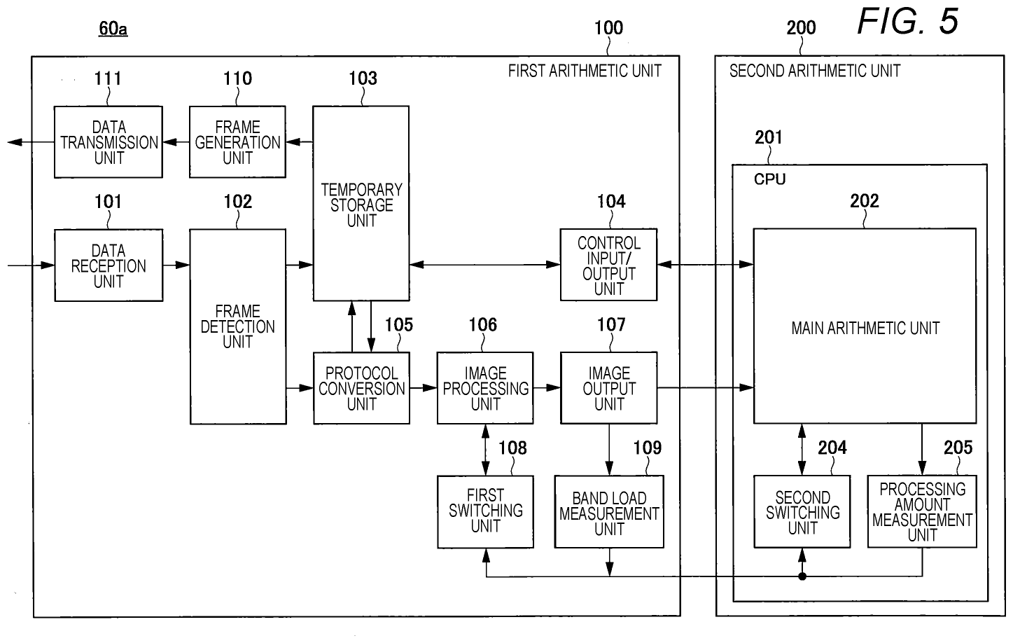

FIG. 5 is a block diagram illustrating a configuration example of an electronic control device (integrated ECU 60a) according to a second embodiment of the present invention. As can be seen by comparing the configuration of the integrated ECU 60a illustrated in FIG. 5 with the configuration of the integrated ECU 60 illustrated in FIG. 2, in the second arithmetic unit 200 of the integrated ECU 60a, the CPU load measurement unit is not provided as the second measurement unit, and instead, a processing amount measurement unit 205 is provided.

The second measurement unit (processing amount measurement unit 205) measures, as a processing load (the processing amount of the CPU 201), an amount of data required for arithmetic processing of the second arithmetic unit (second arithmetic unit 200, CPU 201) that generates vehicle control information on the basis of the arithmetic data input from the first arithmetic unit 100. Note that the processing load (the processing amount of the CPU 201) is not limited to the amount of data required for the arithmetic processing of the second arithmetic unit 200, and may be, for example, the amount of data to be processed by the CPU 201 or the time required for processing a certain amount of data within a certain time. In addition, the processing amount measurement unit 205 outputs the measured processing amount of the CPU 201 to the second switching unit 204 and also transmits the processing amount to the first switching unit 108 of the first arithmetic unit 100.

According to the processing amount of the CPU 201, the switching unit (the first switching unit 108 and the second switching unit 204) causes the first arithmetic unit 100 to perform a part of the arithmetic processing performed by the second arithmetic unit 200 in place of the second arithmetic unit, and adjusts the data amount of the arithmetic data output from the first arithmetic unit 100 to the second arithmetic unit 200 according to the band load. For example, in a case where the amount of data required for the arithmetic processing of the second arithmetic unit that generates the vehicle control information exceeds the predetermined processing load upper limit value, the switching unit (the first switching unit 108 and the second switching unit 204) adjusts the amount of data such that the amount of data of the arithmetic data for which the first arithmetic unit (first arithmetic unit 100) executes the arithmetic processing increases. Note that in a case where the processing amount of the CPU 201 is the time required to process a certain amount of data, the predetermined processing load upper limit value may be, for example, the processing time required when the processing of the certain amount of data is executed by the image processing unit 106 of the first arithmetic unit 100.

Note that the components other than the processing amount measurement unit 205 of the integrated ECU 60a, the first switching unit 108, and the second switching unit 204 are similar to those described with reference to FIG. 2, and thus redundant description will be omitted.

### [Effects]

As described above, in the electronic control device (integrated ECU 60a) according to the second embodiment, the processing amount of the CPU 201 of the second arithmetic unit 200 is measured, and in a case where the measured processing amount (for example, the amount of data required for the arithmetic processing of the second arithmetic unit 200) is equal to or more than the predetermined processing load upper limit value, the switching unit causes the first arithmetic unit 100 to perform a part of the arithmetic processing performed by the second arithmetic unit 200 (for example, image processing) in place of the second arithmetic unit 200. Therefore, the processing load of the CPU 201 of the electronic control device (integrated ECU 60a) according to the second embodiment can be reduced. In addition, the switching unit adjusts the data amount of the arithmetic data output from the first arithmetic unit 100 to the second arithmetic unit 200 according to the band load measured by the band load measurement unit 109, so that not only the load of the in-vehicle network can be reduced, but also the processing load can be reduced by reducing the processing amount of the CPU 201 as a result.

### Third Embodiment

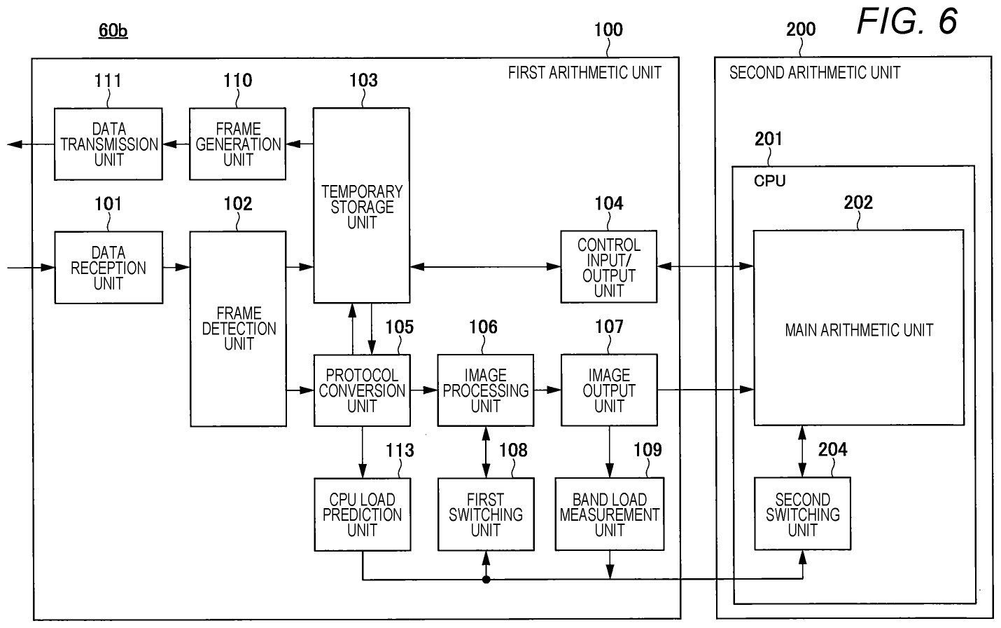

FIG. 6 is a block diagram illustrating a configuration example of an electronic control device (integrated ECU 60b) according to a third embodiment of the present invention. As can be seen by comparing the configuration of the integrated ECU 60b illustrated in FIG. 6 with the configuration of the integrated ECU 60 illustrated in FIG. 2, in the integrated ECU 60b, the CPU load measurement unit 203 (second measurement unit) is not provided inside the CPU 201 of the second arithmetic unit 200, and instead, a CPU load prediction unit 113 is provided as the second measurement unit inside the first arithmetic unit 100.

The CPU load prediction unit 113 is connected to the protocol conversion unit 105, receives the protocol-converted RAW image data from the protocol conversion unit 105, and predicts a CPU load. In addition, the CPU load prediction unit 113 outputs the predicted CPU load to the first switching unit 108 and also transmits the CPU load to the second switching unit 204 of the second arithmetic unit 200.

According to the predicted processing load of the CPU 201, the switching unit (the first switching unit 108 and the second switching unit 204) causes the first arithmetic unit 100 to perform a part of the arithmetic processing performed by the second arithmetic unit 200 in place of the second arithmetic unit, and adjusts the data amount of the arithmetic data output from the first arithmetic unit 100 to the second arithmetic unit 200 according to the band load. For example, in a case where the predicted processing load exceeds the predetermined processing load upper limit value, the switching unit increases the data amount of arithmetic data for which the first arithmetic unit (first arithmetic unit 100) executes arithmetic processing, and adjusts the data amount of arithmetic data output to the second arithmetic unit (second arithmetic unit 200) by the first arithmetic unit (first arithmetic unit 100).

Note that the components other than the CPU load prediction unit 113 of the integrated ECU 60b are similar to those described with reference to FIG. 2, and thus redundant description will be omitted.

In addition, the present embodiment is not limited to the configuration illustrated in FIG. 6, and for example, the processing amount measurement unit 205 (second measurement unit) illustrated in FIG. 5 may not be provided inside the CPU 201 of the second arithmetic unit 200 but may be provided inside the first arithmetic unit 100.

### [Effects]

The electronic control device (integrated ECU 60b) according to the third embodiment in which the second measurement unit (CPU load prediction unit 113) is provided inside the first arithmetic unit 100 can obtain the same effects as those of the electronic control device according to the first embodiment and the second embodiment.

### Fourth Embodiment

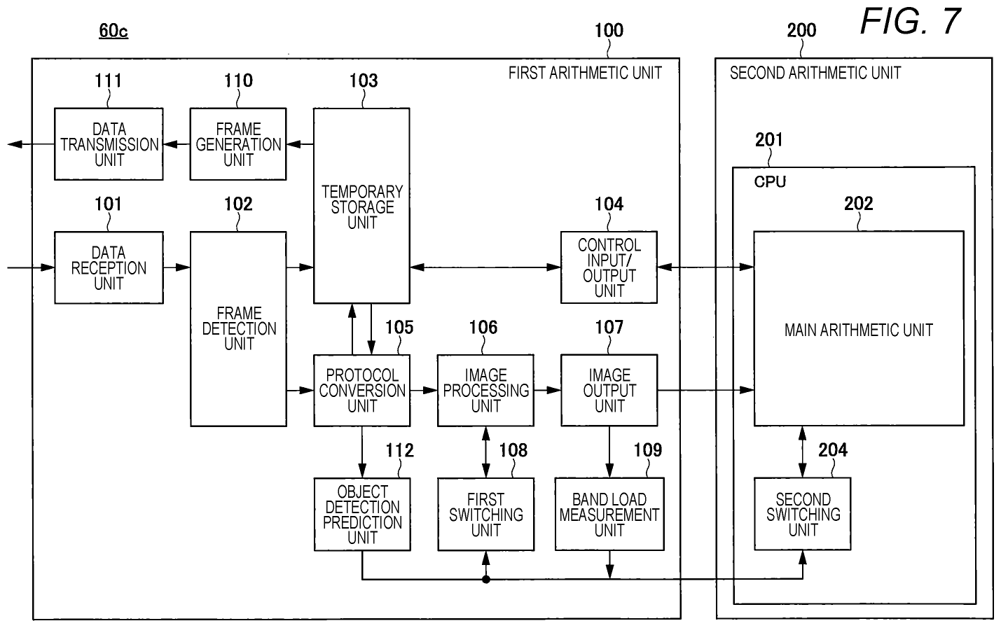

FIG. 7 is a block diagram illustrating a configuration of an electronic control device (integrated ECU 60c) according to a fourth embodiment of the present invention. As can be seen by comparing the configuration of the integrated ECU 60c illustrated in FIG. 7 with the configuration of the integrated ECU 60b illustrated in FIG. 6, in the integrated ECU 60c, as the second measurement unit, the CPU load measurement unit 203 is not provided, and instead, an object detection prediction unit 112 is provided in the first arithmetic unit 100.

The object detection prediction unit 112 is connected to the protocol conversion unit 105, receives the protocol-converted RAW image data from the protocol conversion unit 105, and predicts a place where there is a high possibility of detecting an object from the image. Specifically, the object detection prediction unit 112 scans the input image and predicts a place (image or region) where the object is easily detected and a place image or region where the moving body is likely to be present. For example, the object detection prediction unit 112 compares the preceding and subsequent input images, estimates a place having a large change as a place having a large acceleration, and predicts the place as a place where an object or a moving body is likely to be present. That is, in the present embodiment, the processing load of the second arithmetic unit (CPU 201) is calculated from an image or a region in which an object detectable from image data is predicted. Note that the present embodiment is not limited to this, and as a method of predicting object detection, any method can be applied as long as the method is a method capable of predicting a place where an object, a moving body, or the like in an image is likely to be detected. In addition, the object detection prediction unit 112 outputs, as a prediction result, the number of objects, which are predicted from the input image data and are likely to be detected, to the first switching unit 108, and also transmits the prediction result to the second switching unit 204 of the second arithmetic unit 200. In this case, the predetermined processing load upper limit value for the processing load of the second arithmetic unit 200 is an upper limit value set for the number of objects included in the input image.

In a case where the processing load predicted by the object detection prediction unit 112 exceeds the predetermined processing load upper limit value, the switching unit (the first switching unit 108 and the second switching unit 204) causes the first arithmetic unit (the first arithmetic unit 100) to perform arithmetic processing on the image data. For example, in a case where the number of objects in the image data predicted as the processing load by the object detection prediction unit 112 exceeds the predetermined processing load upper limit value, the first switching unit 108 and the second switching unit 204 may cause the first arithmetic unit 100 to perform a part of the arithmetic processing performed by the second arithmetic unit 200 in place of the second arithmetic unit. Then, the switching unit adjusts the data amount of the arithmetic data output from the first arithmetic unit 100 to the second arithmetic unit 200 according to the band load.

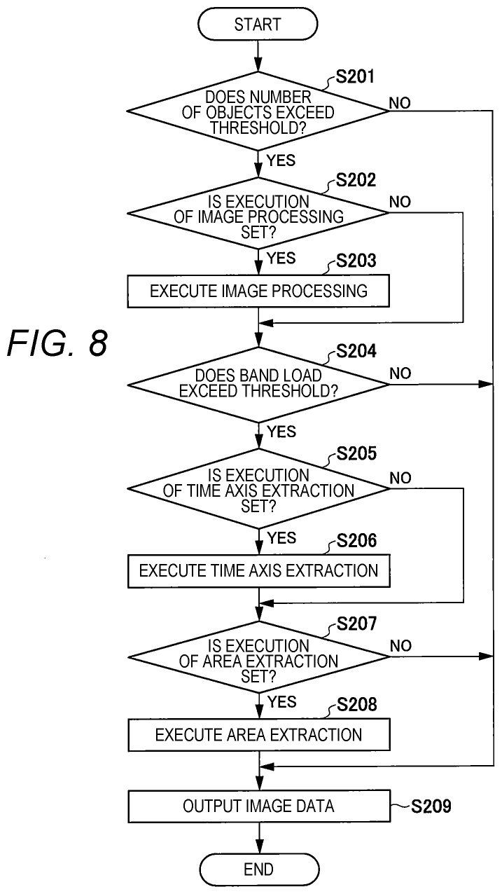

FIG. 8 is a flowchart illustrating a procedure of switching processing in the electronic control device (integrated ECU 60c) according to the present embodiment. The processing described below starts when the first switching unit 108 of the first arithmetic unit 100 inputs the number of objects predicted from the object detection prediction unit 112.

First, the first switching unit 108 of the first arithmetic unit 100 determines whether the predicted number of objects exceeds a predetermined processing load upper limit value (step S201).

In the processing of step S201, if the first switching unit 108 determines that the number of the detected objects does not exceed the predetermined processing load upper limit value (NO of S201), the processing of step S209 described later is performed.

On the other hand, in the processing of step S201, if it is determined that the predicted number of objects exceeds the predetermined processing load upper limit value (YES in S201), the first switching unit 108 determines whether the execution of image processing (RGB conversion processing or the like) is set in the image processing unit 106 (step S202). In this processing, the first switching unit 108 acquires and determines execution setting information of the image processing from the image processing unit 106.

In the processing of step S202, if the first switching unit 108 determines that the execution of the image processing is not set (NO of S202), the processing of step S204 described later is performed.

On the other hand, in the processing of step S202, if the first switching unit 108 determines that the execution of the image processing is set (YES in S202), the first switching unit 108 outputs an instruction to execute the image processing to the image processing unit 106. Then, the image processing unit 106 executes the image processing in accordance with the instruction from the first switching unit 108 (step S203). At this time, the main arithmetic unit 202 does not execute the image processing.

After the processing of step S203 or if the processing of step S202 is NO determination, the first switching unit 108 acquires the band load measured from the band load measurement unit 109 and determines whether the band load exceeds the predetermined band load upper limit value (step S204).

In the processing of step S204, if the first switching unit 108 determines that the band load does not exceed the predetermined band load upper limit value (NO of S204), the processing of step S209 described later is performed.

On the other hand, in the processing of step S204, if it is determined that the band load exceeds the predetermined band load upper limit value (YES in S204), the first switching unit 108 determines whether the execution of time axis extraction processing is set in the image processing unit 106 (step S205). In this processing, the first switching unit 108 acquires and determines execution setting information of the time axis extraction processing from the image processing unit 106.

In the processing of step S205, if the first switching unit 108 determines that the execution of the time axis extraction processing is not set (NO of S205), the processing of step S207 described later is performed.

On the other hand, in the processing of step S205, if the first switching unit 108 determines that the execution of the time axis extraction processing is set (YES of S205), the first switching unit 108 outputs an instruction to execute the time axis extraction processing to the image processing unit 106. Then, the image processing unit 106 performs the time axis extraction processing in accordance with the instruction from the first switching unit 108 (step S206). At this time, the time axis extraction processing is not executed in the main arithmetic unit 202.

After the processing of step S206 or if the processing of step S205 is NO determination, the first switching unit 108 determines whether the execution of the area (XY axes) extraction processing is set in the image processing unit 106 (step S207).

In the processing of step S207, if the first switching unit 108 determines that the execution of the area extraction processing is not set (NO of S207), the processing of step S209 described later is performed.

On the other hand, in the processing of step S207, if the first switching unit 108 determines that the execution of the area extraction processing is set (YES in S207), the first switching unit 108 outputs an instruction to execute the area extraction processing to the image processing unit 106. Then, the image processing unit 106 performs the area extraction processing in accordance with the instruction from the first switching unit 108 (step S208). At this time, the area extraction processing is not executed in the main arithmetic unit 202.

After the processing of step S208, if the processing of step S201 is NO determination, if the processing of step S204 is NO determination, or if the processing of step S207 is NO determination, the image processing unit 106 outputs the image data to the image output unit 107 (step S209). After the processing of step S209, the switching processing in the integrated ECU 60c ends.

Note that the present embodiment is not limited to the switching processing described above. For example, in the first arithmetic unit 100 of the integrated ECU 60c, in a case where the measured band load exceeds the predetermined processing load upper limit value, the frame rate of an image in which the predicted object is likely to be detected may be reduced, and a part of the image may not be output. In addition, in a case where a plurality of sensor images is output in the first arithmetic unit 100, it is also possible to preferentially output, as an image with high priority, an image in which an object is easily detected, compared with an image in which an object is hardly detected. As a method of preferentially outputting an image, the amount of information may be reduced by reducing the frame rate of image data in which an object is easily detected or limiting the area thereof, or the image data in which an object is easily detected may be output. In addition, as the method of preferentially outputting an image, an image having an error such as missing lines in the process of scanning the image may be set to have the lowest priority so as not to be output. Note that the present embodiment is not limited to this, and a factor for determining the priority may be appropriately specified. For example, image data from a specific sensor may be preferentially designated as an initial value in advance, or image data from a sensor in a certain direction or image data from a sensor in a certain time zone may be preferentially designated according to a certain condition. For example, when the traveling direction of the vehicle is the forward direction of the vehicle, the priority of the image data from the sensor installed in the front of the vehicle may be set higher than the priority of the image data from the sensor installed in the rear of the vehicle.

In addition, in a case where image processing is executed in the second arithmetic unit 200, for example, image quality improvement processing may be executed on a poor image having a detected error. In addition, the second arithmetic unit 200 may execute image processing on an image having a high priority in advance. Note that by reducing the amount of information of an image with low priority, the CPU can be allocated to image processing of an image with high priority as a result.

Note that the components other than the object detection prediction unit 112 of the integrated ECU 60c, the first switching unit 108, and the second switching unit 204 are similar to those described with reference to FIG. 2, and thus redundant description will be omitted.

### [Effects]

As described above, in the first arithmetic unit 100 of the electronic control device (integrated ECU 60c) according to the fourth embodiment, the object detection prediction unit 112 predicts an object detectable from the input image data. In a case where the predicted number of objects exceeds the predetermined processing load upper limit value, the switching unit causes the first arithmetic unit 100 to perform a part of the arithmetic processing performed by the second arithmetic unit 200 in place of the second arithmetic unit. In addition, in the integrated ECU 60c according to the fourth embodiment, in a case where the measured band load of the in-vehicle network exceeds the predetermined band load upper limit value, the switching unit adjusts the data amount such that the data amount of the arithmetic data output to the second arithmetic unit 200 by the first arithmetic unit 100 does not increase. Therefore, in the integrated ECU 60c according to the fourth embodiment, the band load of the in-vehicle network is reduced, and the data amount of the image processing in the CPU 201 of the second arithmetic unit 200 is also reduced, so that the processing load of the CPU 201 can be reduced. In addition, the second arithmetic unit 200 of the integrated ECU 60c adjusts the data amount of the target image data of the image processing according to the result of the object detection, so that the processing load of the CPU 201 can be further reduced.

### Fifth Embodiment

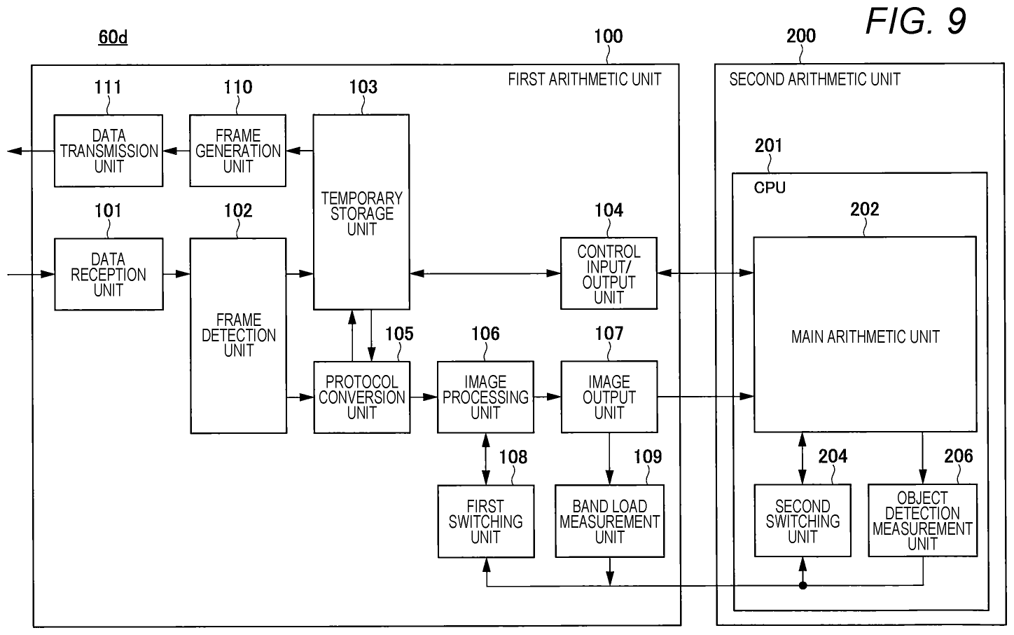

FIG. 9 is a block diagram illustrating a configuration of an electronic control device (integrated ECU 60d) according to a fifth embodiment of the present invention. As can be seen by comparing the configuration of the integrated ECU 60d illustrated in FIG. 9 with the configuration of the integrated ECU 60c illustrated in FIG. 7, in the integrated ECU 60d, the object detection prediction unit 112 is not provided inside the first arithmetic unit 100, and instead, an object detection measurement unit 206 is provided inside the CPU 201 of the second arithmetic unit 200. In the fifth embodiment, arithmetic data to be subjected to arithmetic processing is used as image data.

The object detection measurement unit 206 performs object detection on the image data input from the first arithmetic unit 100, and outputs the number of objects detected from the image data to the first switching unit 108 of the first arithmetic unit 100 and the second switching unit 204 of the second arithmetic unit 200. Here, the processing load detected by the object detection and measurement unit 206 is measured as the number of objects detected from the image data.

In a case where the number (processing load) of objects detected by the object detection measurement unit 206 exceeds the predetermined processing load upper limit value, the switching unit (the first switching unit 108 and the second switching unit 204) causes the first arithmetic unit to perform arithmetic processing on the image data. For example, the first switching unit 108 and the second switching unit 204 cause the first arithmetic unit 100 to perform arithmetic processing on image data in which an object is detected, the arithmetic processing being performed by the second arithmetic unit (second arithmetic unit 200). In addition, the switching unit adjusts the data amount of the arithmetic data output from the first arithmetic unit 100 to the second arithmetic unit 200 according to the band load.

Note that the components other than the object detection measurement unit 206 of the integrated ECU 60d are similar to those described with reference to FIG. 7, and thus redundant description will be omitted.

### [Effects]

In the electronic control device (integrated ECU 60d) according to the fifth embodiment, the switching processing of the image processing based on the object detection result of the object detection measurement unit 206 is similar to the processing described with reference to FIG. 8, and the setting method and the like in the case of setting the priority of the image are also similar. Therefore, the electronic control device (integrated ECU 60d) according to the fifth embodiment can obtain the same effect as the electronic control device according to the fourth embodiment.

### Sixth Embodiment

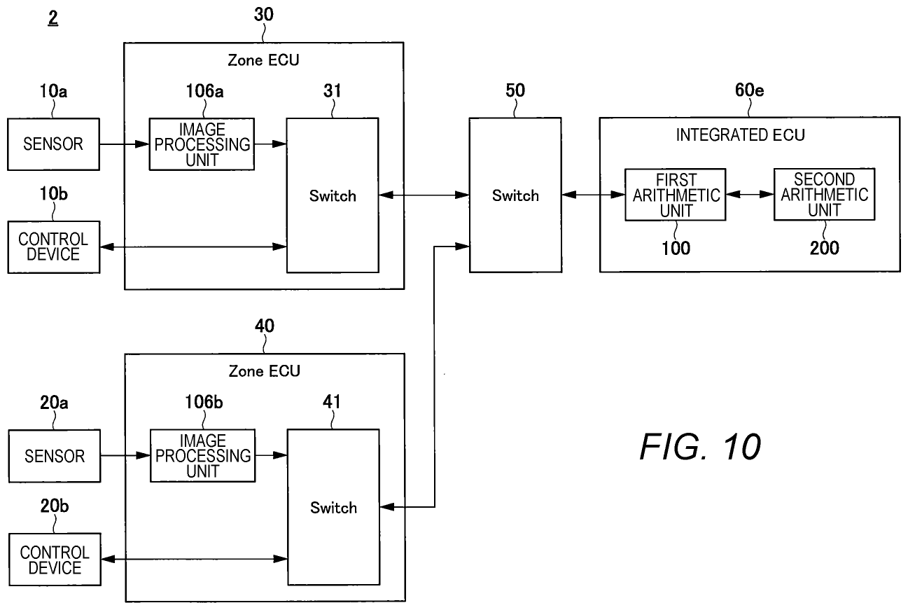

FIG. 10 is a block diagram illustrating a configuration example of a vehicle control system 2 according to a sixth embodiment of the present invention. As illustrated in FIG. 10, in the vehicle control system 2, the Zone ECU 30 includes an image processing unit 106a and a Switch 31. Similarly, the Zone ECU 40 includes an image processing unit 106b and a Switch 41. Note that the image processing unit 106a and the image processing unit 106b (image processing unit) have a function of performing arithmetic processing on image data, similarly to the image processing unit 106 described with reference to FIG. 2. In the sixth embodiment, arithmetic data to be subjected to arithmetic processing is used as image data. The Switch 31 selects the image data output from the image processing unit 106a and the control data output from the control device 10b on the basis of the priority order registered in advance, and outputs the image data and the control data to the Switch 50. For example, in a case where the image data and the control data arrive at the same time, the Switch 31 preferentially outputs the image data to the Switch 50 and then outputs the control data to the Switch 50. The Switch 41 operates similarly to the Switch 31, and thus redundant description will be omitted. Note that in the sixth embodiment, the sensors 10a and 20a acquire image data.

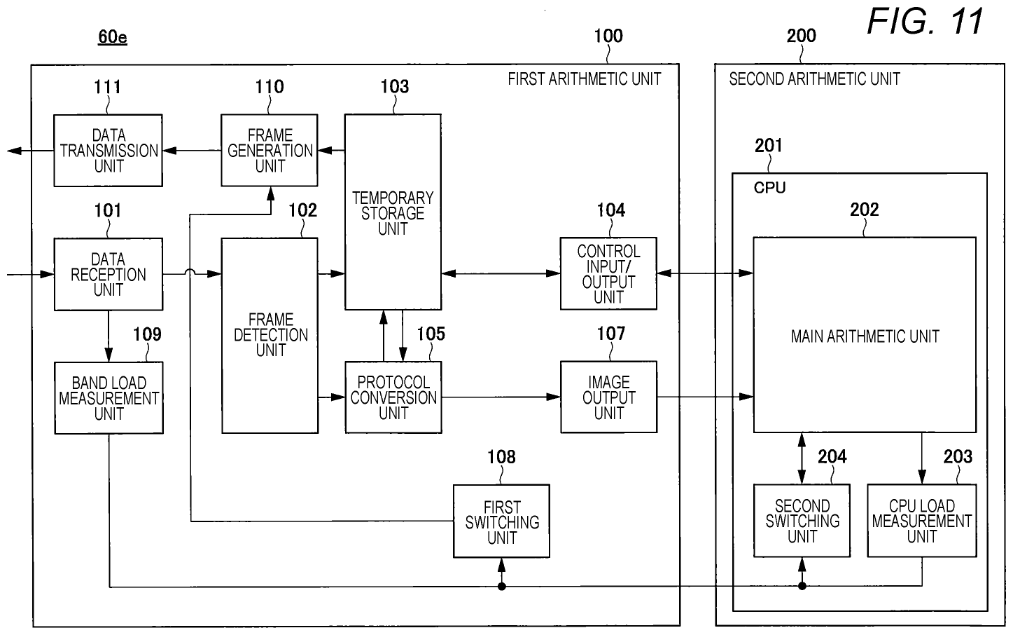

FIG. 11 is a block diagram illustrating a configuration of an electronic control device (integrated ECU 60e) according to the sixth embodiment of the present invention. As can be seen by comparing the configuration of the integrated ECU 60e illustrated in FIG. 11 with the configuration of the integrated ECU 60 illustrated in FIG. 2, the integrated ECU 60e does not include the image processing unit 106. In addition, in the integrated ECU 60e, the first switching unit 108 outputs, to the frame generation unit 110, an instruction as to whether to execute image processing. The instruction of the first switching unit 108 is transmitted to the image processing unit 106a of the Zone ECU 30 or the image processing unit 106b of the Zone ECU 40 via the frame generation unit 110 and the data transmission unit 111. The image processing unit (image processing unit 106a, 106b) performs arithmetic processing on the image data acquired by the sensor (sensor 10a, 20a).

In addition, in the integrated ECU 60e, the band load measurement unit 109 measures the band load of the communication path between each of the Zone ECUs 30 and 40 and the integrated ECU 60e on the basis of the data amount of the image data received by the data reception unit 101.

In a case where the processing load of the CPU 201 exceeds the predetermined processing load upper limit value, the switching unit (the first switching unit 108 and the second switching unit 204) causes the image processing units (image processing units 106a and 106b) of the Zone ECUs 30 and 40 to perform a part of the arithmetic processing performed by the second arithmetic unit (the second arithmetic unit 200). In this case, the image data transmitted from the Zone ECUs 30 and 40 to the integrated ECU 60e is RGB image data after image processing. Therefore, in a case where the band load of the communication path between each of the Zone ECUs 30 and 40 and the integrated ECU 60e becomes heavy and the band load measured by the band load measurement unit 109 exceeds the predetermined band load upper limit value, the first switching unit 108 and the second switching unit 204 may instruct not to switch the image processing. In addition, in this case, the first switching unit 108 may issue an instruction to execute extraction processing of image data in the image processing units 106a and 106b of the Zone ECUs 30 and 40. In this way, the amount of image data transmitted from the Zone ECUs 30 and 40 to the integrated ECU 60e is reduced, so that the band load can be reduced.

Note that although a configuration example in which the image processing unit 106 is not provided in the first arithmetic unit 100 has been described in FIG. 10, the present embodiment is not limited thereto, and the image processing unit may be provided in each of the first arithmetic unit 100 and the Zone ECUs 30 and 40. In this case, the image processing is switched among the second arithmetic unit 200, the first arithmetic unit 100, and the Zone ECUs 30 and 40 on the basis of the processing load of the CPU 201 of the second arithmetic unit 200 and the band load of the in-vehicle network.

In addition, in FIG. 10, a configuration in which the image processing units 106a and 106b are provided in the Zone ECUs 30 and 40 has been described, but the present embodiment is not limited thereto. For example, the first arithmetic unit 100 illustrated in FIG. 1 may be provided in each of the Zone ECUs 30 and 40.

In addition, in FIG. 11, an example in which the image processing units 106a and 106b are provided in the Zone ECUs 30 and 40 has been described, but the present embodiment is not limited thereto. For example, in a case where each sensor is an imaging device or the like having an image processing unit capable of executing image processing, when the processing load measured by the second measurement unit exceeds the predetermined processing load upper limit value, switching may be performed such that the image processing (arithmetic processing) is executed by the image processing unit of each sensor.

### [Effects]

In the (integrated ECU 60e) according to the sixth embodiment, the image processing unit is not provided in the integrated ECU 60e, but is provided inside each of the Zone ECUs 30 and 40. In addition, in a case where a sensor having an image processing function is used, the image processing may be switched to the image processing function in the sensor. The vehicle control system 2 having such a configuration can obtain an effect similar to that of the vehicle control system having the electronic control device of each embodiment described above.

### <Various Modifications>

The present invention is not limited to the above-described embodiments, and it is needless to say that various other application examples and modifications can be taken without departing from the gist of the present invention described in the claims.

For example, the above-described embodiments describe the configurations of the vehicle control system and the electronic control device in detail and specifically for easy understanding of the present invention, and are not necessarily limited to those having all the described configurations. In addition, a part of the configuration of the embodiment described here can be replaced with the configuration of another embodiment, and furthermore, the configuration of another embodiment can be added to the configuration of an embodiment. In addition, it is also possible to add, delete, and replace other configurations for a part of the configuration of each embodiment.

In addition, the control lines and the information lines indicate what is considered to be necessary for the description, and do not necessarily indicate all the control lines and the information lines on the product. In practice, it may be considered that almost all the configurations are connected to each other.

In addition, in each of the above-described embodiments, RGB image conversion has been described as an example of image processing, but the present invention is not limited thereto. For example, image conversion between different formats or the like may be included in the image processing. In addition, for example, various types of processing such as processing of frame rate reduction, image area limitation, image quality correction, and image quality improvement are included in the image processing, and can be configured and switched in the same manner as the electronic control device according to each of the above-described embodiments.

In addition, in each of the above-described embodiments, the switching control of the image processing for the image data has been described as an example, but the present invention is not limited thereto. For example, the switching control may be performed on various types of arithmetic processing using control data.

In addition, in each of the above-described embodiments, a configuration example in which the image processing unit is provided inside at least one of the first arithmetic unit 100, each Zone ECU, and each sensor of the integrated ECU has been described, but the present invention is not limited thereto. For example, in a case where the image processing unit is not provided in any of the first arithmetic unit of the integrated ECU, each Zone ECU, and each sensor, the image processing unit, that is, the component that executes the arithmetic processing may be provided as an independent component in the vehicle control system.

In addition, in each of the above-described embodiments, an example in which the integrated ECU includes the first arithmetic unit 100, the second arithmetic unit 200, the first measurement unit, the second measurement unit, and the switching unit has been described, but the present invention is not limited thereto. For example, in a case where the vehicle control system includes a plurality of electronic control devices (Zone ECU and integrated ECU) capable of communicating with each other, at least one electronic control device of the plurality of electronic control devices may include the first arithmetic unit, the second arithmetic unit, the first measurement unit, the second measurement unit, and the switching unit (first switching unit 108 and second switching unit 204), and acquire arithmetic data from another electronic control device. In addition, for example, in a case where the vehicle control system includes a plurality of electronic control devices capable of communicating with each other, at least one electronic control device among the plurality of electronic control devices may include the second arithmetic unit, the first measurement unit, the second measurement unit, and the switching unit, and at least one of the other electronic control devices may include the electronic control device including the first arithmetic unit. As described above, the type and number of functional units that can be arranged in the electronic control device can be arbitrarily changed.

In addition, in each of the above-described embodiments, a configuration example in which the first switching unit 108 of the first arithmetic unit 100 and the second arithmetic unit 200 the second switching unit 204 are integrated into the switching unit has been described, but the present invention is not limited thereto. For example, the functions of the first switching unit 108 of the first arithmetic unit 100 and the second arithmetic unit 200 the second switching unit 204 may be combined into one functional unit to form one switching unit. In this case, the switching unit is installed in the first arithmetic unit 100 or the second arithmetic unit 200. In order to further reduce the processing load of the CPU 201 of the second arithmetic unit 200, it is sufficient if the switching unit is installed in the first arithmetic unit 100.

In addition, in each of the above-described embodiments, the instruction information of the switching control is illustrated by dedicated lines in each drawing, but the dedicated lines may not be actually installed. For example, the instruction information of the switching control may be transmitted and received in a specific packet or frame.

### REFERENCE SIGNS LIST

1 vehicle control system
100 first arithmetic unit
10a, 20a sensor
10b, 20b control device
30, 40 Zone ECU
50 Switch
60 integrated ECU
101 data reception unit
102 frame detection unit
103 temporary storage unit
104 control input/output unit
105 protocol conversion unit
106 image processing unit
107 image output unit
108 first switching unit
109 band load measurement unit
110 frame generation unit
111 data transmission unit
112 object detection prediction unit
113 CPU load prediction unit
200 second arithmetic unit
201 CPU
202 main arithmetic unit
203 CPU load measurement unit
204 second switching unit

1. A vehicle control system comprising:
a first arithmetic unit that acquires arithmetic data and is capable of executing arithmetic processing;
a second arithmetic unit that is connected to a subsequent stage of the first arithmetic unit via a network and is capable of executing arithmetic processing of the arithmetic data input from the first arithmetic unit via the network;
a first measurement unit that measures a band load of the network;
a second measurement unit that measures a processing load of the arithmetic processing by the second arithmetic unit; and
a switching unit that causes the first arithmetic unit to perform a part of the arithmetic processing performed by the second arithmetic unit in place of the second arithmetic unit according to the processing load, and adjusts a data amount of the arithmetic data output from the first arithmetic unit to the second arithmetic unit according to the band load.

2. The vehicle control system according to claim 1, wherein in a case where the band load does not exceed a predetermined band load upper limit value and the processing load exceeds a predetermined processing load upper limit value, the switching unit adjusts the data amount such that the data amount of the arithmetic data for which the first arithmetic unit executes the arithmetic processing increases.

3. The vehicle control system according to claim 2, wherein in a case where the band load exceeds the predetermined band load upper limit value and the processing load exceeds the predetermined processing load upper limit value, the switching unit adjusts the data amount such that the data amount of the arithmetic data output to the second arithmetic unit by the first arithmetic unit does not increase.

4. The vehicle control system according to claim 3, wherein
the band load is a usage rate of a band of the network, and
the processing load is a usage rate of the second arithmetic unit that generates vehicle control information on a basis of the arithmetic data input from the first arithmetic unit.

5. The vehicle control system according to claim 2, wherein
the band load is a usage rate of a band of the network,
the processing load is a data amount required for the arithmetic processing of the second arithmetic unit that generates vehicle control information on a basis of the arithmetic data input from the first arithmetic unit, and
in a case where the data amount exceeds the predetermined processing load upper limit value, the switching unit adjusts the data amount such that the data amount of the arithmetic data for which the first arithmetic unit executes the arithmetic processing increases.

6. The vehicle control system according to claim 2, wherein
the second measurement unit predicts a processing load of the arithmetic processing by the second arithmetic unit, and
in a case where the predicted processing load exceeds the predetermined processing load upper limit value, the switching unit increases the data amount of the arithmetic data for which the first arithmetic unit executes the arithmetic processing, and adjusts the data amount of the arithmetic data output to the second arithmetic unit by the first arithmetic unit.

7. The vehicle control system according to claim 2, wherein
the arithmetic data is image data,
the processing load is calculated from an image or a region in which an object detectable from the image data is predicted, and
in a case where the processing load exceeds the predetermined processing load upper limit value, the switching unit causes the first arithmetic unit to perform the arithmetic processing on the image data.

8. The vehicle control system according to claim 2, wherein
the arithmetic data is image data,
the processing load is measured as the number of objects detected from the image data, and
in a case where the processing load exceeds the predetermined processing load upper limit value, the switching unit causes the first arithmetic unit to perform the arithmetic processing on the image data.

9. The vehicle control system according to claim 2, wherein
the arithmetic data is image data, the vehicle control system comprising:
a sensor that acquires the image data; and
an image processing unit that performs arithmetic processing on the image data acquired by the sensor, and
in a case where the processing load exceeds the predetermined processing load upper limit value, the switching unit causes the image processing unit to perform a part of the arithmetic processing performed by the second arithmetic unit.

10. The vehicle control system according to claim 2, comprising
a plurality of electronic control devices capable of communicating with each other,
wherein at least one electronic control device of the plurality of electronic control devices includes the first arithmetic unit, the second arithmetic unit, the first measurement unit, the second measurement unit, and the switching unit, and acquires the arithmetic data from another electronic control device.

11. The vehicle control system according to claim 2, comprising
a plurality of electronic control devices capable of communicating with each other,
wherein at least one electronic control device of the plurality of electronic control devices includes the second arithmetic unit, the first measurement unit, the second measurement unit, and the switching unit, and
at least one of other electronic control devices includes an electronic control device including the first arithmetic unit.

12. An electronic control device comprising:
a first arithmetic unit that acquires arithmetic data and is capable of executing arithmetic processing;
a second arithmetic unit that is connected to a subsequent stage of the first arithmetic unit via a network, receives the arithmetic data transmitted from the first arithmetic unit via the network, and performs arithmetic processing;
a first measurement unit that measures a band load of the network;
a second measurement unit that measures a processing load of the arithmetic processing by the second arithmetic unit; and
a switching unit that causes the first arithmetic unit to perform a part of the arithmetic processing performed by the second arithmetic unit in place of the second arithmetic unit according to the processing load, and adjusts a data amount of the arithmetic data output from the first arithmetic unit to the second arithmetic unit according to the band load.
